(19) United States
(12) Patent Application Publication
(10) Pub. No.: US 2024/0034034 A1
(43) Pub. Date: Feb. 1, 2024

(54) MULTI-LAYER STRUCTURE FOR A REINFORCED, RECYCLABLE FLOOR COVERING

(71) Applicant: Gerflor, Villeurbanne (FR)

(72) Inventor: Nicolas CINAUSERO, Fontaines Saint Martin (FR)

(73) Assignee: Gerflor, Villeurbanne (FR)

(21) Appl. No.: 18/226,287

(22) Filed: Jul. 26, 2023

(30) Foreign Application Priority Data
Jul. 29, 2022 (FR) 2207915
Jul. 11, 2023 (FR) 2307451

(51) Int. Cl. B32B 27/30; B32B 5/02; B32B 7/12; B32B 27/12; B32B 33/00

(52) U.S. Cl. CPC B32B 27/304; B32B 5/024; B32B 7/12; B32B 27/12; B32B 33/00; B32B 2307/7376; B32B 2307/546; B32B 27/22

(57) ABSTRACT

Multilayer structure for the production of a floor covering, comprising at least one surface layer bonded to a backing layer, wherein the surface layer and the backing layer are made of PVC; wherein the multilayer structure has a basis weight ranging from 1500 to 2500 g/m², preferably between 1600 and 1900 g/m², and a woven reinforcement bonded to the surface layer and the backing layer through adhesive layers in the form of thermofusible films or copolyester, or cross-linked polyurethane adhesive layers; and wherein the backing layer made of PVC comprises:
a thickness ranging from 150 μm to 600 μm, preferably between 150 μm and 300 μm,
less than 25 PCR of plasticizer, preferably less than 15 PCR.

### RELATED APPLICATION

This application claims the benefit of priority of France Patent Application Nos. 2307451 filed on Jul. 11, 2023 and 2207915 filed on Jul. 29, 2022, the contents of which are incorporated by reference as if fully set forth herein in their entirety.

### FIELD AND BACKGROUND OF THE INVENTION

The invention relates to the technical field of flexible floor coverings, preferably presented in roll form or as a welded and adhesive kit.

The invention concerns a multilayer structure for the production of reinforced and recyclable flooring.

The invention finds advantageous application in coating honeycomb aircraft floor panels, for example.

A multilayer structure for the production of flooring is well known in the prior art, comprising a surface layer bonded to a so-called “laminate” backing layer used, for example, to coat aircraft floors.

In this type of structure, the laminate backing layer is made of a woven reinforcement of glass fibers impregnated with phenolic or polyester resins. This backing layer ensures the flooring's adherence to its support, provides dimensional stability, blocks the migration of plasticizers from the PVC surface layers, and improves the impact resistance of the flooring.

The production of the laminate backing layer is complex and requires certain technical expertise, possessed by only a limited number of companies, resulting in high production costs.

Another drawback of this laminate backing layer is that it is not recyclable due to the use of phenolic resin. Currently, the waste generated from the production of flooring containing this type of layer is mostly discarded.

The prior art documents US2010/0227132 and EP3064347 describe multilayer structures for the production of floor coverings in which a backing layer is composed of a composite material comprising woven or non-woven reinforcement fibers and a thermosetting or thermoplastic polymer resin chosen from the group consisting of polyester resin, phenolic resin, epoxy resin, polysulfone, vinyl ester resin, epoxy-acrylic resin, and their mixtures.

The resulting drawback is that the use of a thermosetting resin affects the recyclability of the flooring.

Replacing the phenolic resin with a thermoplastic resin can also affect recyclability because the structure becomes too heterogeneous. Furthermore, the expected performance of the multilayer structure is not achieved, such as weldability between two structures or resistance to traffic, for example.

### SUMMARY OF THE INVENTION

One of the objectives of the invention is to overcome the drawbacks of the prior art by providing a multilayer structure, for example, used to coat aircraft floors, which has a low manufacturing cost compared to laminate layers. It aims to provide a multilayer structure that fully satisfies the requirements in terms of the flooring's adherence to its support, dimensional stability, and impact resistance.

Another objective of the invention is to improve the recyclability of such a multilayer structure.

To this end, a multilayer structure has been developed for the production of flooring, comprising at least one surface layer bonded to a backing layer, with both the surface layer and the backing layer made from PVC.

According to the invention, the multilayer structure comprises a surface mass ranging from 1500 to 2500 g/m², preferably between 1600 and 1900 g/m², and a woven reinforcement bonded to the surface layer and the backing layer through bonding layers in the form of thermofusible films (e.g., copolyamide CoPA and thermoplastic polyurethane TPU, or thermoplastic copolyester CoPES), or a cross-linked polyurethane adhesive layer. The backing layer made from PVC includes:
A thickness ranging from 150 μm to 600 μm, preferably between 150 μm and 300 μm.
Less than 25 PCR (parts per hundred resin), preferably less than 15 PCR, or even between 18 and 23 PCR, of plasticizer.

The backing layer preferably contains more than 5 PCR of plasticizer.

The woven reinforcement enhances the rigidity and dimensional stability of the multilayer structure.

The amount of plasticizer is directly related to the amount of flame retardant required in the composition, as plasticizers are flammable compounds. By limiting the amount of plasticizer to 25 PCR, preferably 15 PCR, the quantity of flame retardant can be reduced, minimizing the migration of plasticizers into the double-sided adhesives typically used to bond the multilayer structure to a honeycomb floor of an aircraft. Consequently, it avoids degrading the adhesive properties over time. Advantageously, the amount of plasticizer in the backing layer is greater than 5 PCR, preferably between 18 and 23 PCR, to achieve a sufficiently flexible layer without compromising fire performance and welding behavior. A low plasticizer content results in a film with low dimensional stability and heat sensitivity, particularly in hot welding processes.

Thus, the multilayer structure according to the invention includes a backing layer, allowing for a relatively low manufacturing cost of the flooring while satisfying requirements in terms of its adherence to the support, dimensional stability, and impact resistance. Since both the surface layer and the backing layer are made of PVC, the recyclability of the multilayer structure becomes feasible.

Preferably, the backing layer made from PVC has a bending resistance, measured according to ISO 2493-2, ranging from 0.10 mN·m to 30 mN·m, preferably between 0.1 and 2.0 mN·m, and more preferably between 0.1 and 1.0 mN·m.

Preferably, the backing layer has a thickness ranging from 150 μm to 300 μm, preferably between 170 μm and 250 μm, to limit the overall weight and improve maneuverability of the structure.

Preferably, the backing layer contains 2% or less of flame retardant.

In a particular embodiment, the surface layer includes an upper layer, such as a wear layer, and one or more intermediate layers of plasticized PVC.

For example, the upper layer is transparent, and a first intermediate layer directly under the surface layer is in the form of a printed film with a decorative pattern. In this case, a second intermediate layer is preferably placed under the printed film to provide sufficient opacity.

In a particular embodiment, the woven reinforcement is impregnated with a thermoplastic or thermosetting polymer in an amount ranging from 1% to 10% by weight of the impregnated woven reinforcement to avoid compromising recyclability. This impregnation enhances the rigidity of the multilayer structure. The thermoplastic or thermosetting polymer can be selected from the group consisting of polyurethane resin, polyester resin, phenolic resin, epoxy resin, polysulfone, vinyl ester resin, epoxy-acrylic resin, and their mixtures.

Preferably, and to improve resistance to the phenomenon known as “telegraphing,” a non-woven layer, preferably containing aramid fibers for fire resistance properties, is bonded to the lower side of the backing layer through a bonding layer (6) in the form of a cross-linked polyurethane layer PUR or a thermoplastic copolyester layer CoPES.

Advantageously, to facilitate the installation of the multilayer structure according to the invention, the structure includes a repositionable adhesive layer on the lower side, intended to be in contact with the floor, i.e., directly on the lower side of the backing layer or on the lower side of the non-woven layer. The repositionable adhesive layer has higher adhesion to the multilayer structure than to the floor, allowing the structure to be peeled off and repositioned.

The invention also pertains to an aircraft or aircraft whose floors are at least partially covered by said multilayer structure.

### BRIEF DESCRIPTION OF THE SEVERAL VIEWS OF THE DRAWINGS

FIG. 1 illustrates in cross-section a multilayer structure according to a first embodiment of the invention, with a surface layer, an intermediate layer, a woven reinforcement, and a backing layer.

FIG. 2 is a similar view to that of FIG. 1, with two intermediate layers.

FIG. 3 is a similar view to that of FIG. 2, with an additional non-woven layer on the lower side of the backing layer and a repositionable adhesive layer facing the floor.

### DESCRIPTION OF SPECIFIC EMBODIMENTS OF THE INVENTION

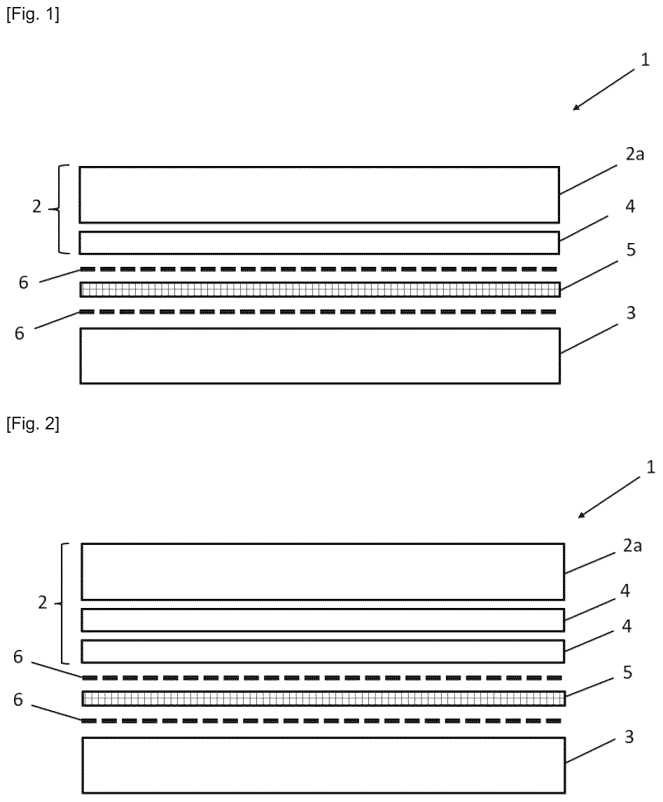

Referring to FIGS. 1 to 3, the invention relates to a multilayer structure (1) for the production of flooring, preferably for covering aircraft floors, such as honeycomb floors, without being limiting.

The multilayer structure (1) according to the invention has a low manufacturing cost while offering optimal performance in terms of adherence to the support, dimensional stability, impact resistance, and recyclability.

To this end, the multilayer structure (1) according to the invention comprises at least one surface layer (2) made from PVC, bonded to a backing layer (3), also made from PVC

According to the invention, the multilayer structure (1) comprises a surface mass ranging from 1500 to 2500 g/m², preferably between 1600 and 1900 g/m², and a woven reinforcement (5) bonded to the surface layer (2) and the backing layer (3) through bonding layers (6) in the form of thermofusible films or copolyester layers, or cross-linked polyurethane adhesive layers.

The backing layer (3) made from PVC includes:
A thickness ranging from 150 μm to 600 μm, preferably between 200 μm and 500 μm, or even between 150 μm and 300 μm to limit the weight of the overall structure (1).
An amount of plasticizer less than 25 PCR (parts per hundred resin), or even less than 15 PCR, preferably greater than 5 PCR to achieve sufficient dimensional stability during thermowelding processes. “PCR” stands for parts per hundred resin, with the term “resin” referring to the PVC of the backing layer (3).
Preferably, a bending resistance, specifically B-bending resistance of PVC films measured according to ISO 2493-2 on a “Taber Stiffness” test bench from “Taber Industries,” model “TABER 150-E,” ranging from 0.1 mN·m to 30 mN·m, or between 0.1 mN·m and 2.0 mN·m, preferably between 0.1 mN·m and 1.0 mN·m.
Preferably, a quantity of flame retardant, such as antimony, equal to or less than 2% (by weight of the PVC backing layer).

The backing layer (3) may not contain fillers or may optionally include a quantity of fillers ranging from 1 to 50 PCR. The fillers can be selected from the group consisting of calcium carbonate, chalk, kaolin, talc, and silica. Additionally, the backing layer (3) may contain at least one additive selected from the group including thermal stabilizers, desiccants, lubricants, processing aids, pigments, and flame retardants.

Limiting the amount of plasticizer helps reduce the quantity of flame retardant and restricts the migration of plasticizers into the double-sided adhesives commonly used to bond the multilayer structure (1) to a floor, thereby preserving the adhesive properties of the adhesives over time. Advantageously, the amount of plasticizer in the backing layer (3) is between 18 and 23 PCR to achieve sufficient flexibility without compromising the adhesion performance of the multilayer structure (1) with the double-sided adhesives commonly used to bond the multilayer structure (1) to a honeycomb floor of an aircraft, for example.

The bending resistance is tested in the machine direction, and the bending resistance is determined as the average bending moment of 10 measured values, with 5 bending movements in one direction and 5 bending movements in the opposite direction. A bending resistance ranging from 0.1 mN·m to 2 mN·m provides sufficient rigidity to the structure.

The surface layer (2) may include an upper layer (2a), particularly a wear layer, and one or more intermediate layers (4) of plasticized PVC. For example, each intermediate layer (4) may not contain fillers or optionally include a quantity of fillers ranging from 1 to 150 PCR. The fillers can be selected from the group consisting of calcium carbonate, chalk, kaolin, talc, and silica. Additionally, each intermediate layer (4) may contain at least one additive selected from the group including thermal stabilizers, desiccants, lubricants, processing aids, pigments, and flame retardants.

The upper layer (2a) and the intermediate layers (4) are made integral, for example, through lamination by hot pressing. For example, the upper layer (2a) has a thickness ranging from 0.35 mm to 0.55 mm, and the intermediate layer (4) has a thickness ranging from 0.15 mm to 0.60 mm.

The upper layer (2a) is plasticized and optionally filled, and may have a well-known surface varnish to facilitate maintenance.

In a particular embodiment, the upper layer (2a) is transparent to visible light for the human eye, and the intermediate layer (4), directly positioned under the upper layer (2a), may be in the form of a printed film with a decorative pattern on its surface facing the upper layer (2). In this case, it is preferable to have a second intermediate layer (4) positioned under the printed film to ensure sufficient opacity for the pattern and prevent the structure of the woven reinforcement (5) from being visible. Alternatively, a pattern can be directly printed on the underside of the upper layer (2), facing the intermediate layer (4).

The woven reinforcement (5) ensures dimensional stability of the multilayer structure (1) and may take the form of a glass fabric, for example.

Due to the lack of affinity between the woven reinforcement (5) and PVC, the woven reinforcement (5) is bonded to the surface layer (2) and the backing layer (3) through bonding layers (6), such as thermofusible films (e.g., copolyamide CoPA in thermoplastic polyurethane TPU, or thermoplastic copolyester CoPES), or cross-linked polyurethane (PUR) layers applied as a well-known adhesive by the person skilled in the art, commonly referred to as “hotmelt.”

The woven reinforcement (5) is preferably woven in a plain weave, without being limiting. It could also be woven in a twill or satin weave.

The woven reinforcement (5) is preferably made from fiberglass, polyamide fibers, or polyester fibers.

The fiberglass fibers can have a denier ranging from 22 Tex to 68 Tex. The polyester fibers can have a denier around 1100 decitex. The polyamide fibers can have a denier ranging from 44 decitex to 78 decitex. The woven reinforcement (5) generally has a thickness ranging from 150 μm to 300 μm, preferably between 165 μm and 205 μm. The woven reinforcement (5) has a surface mass ranging from 150 g/m² to 300 g/m², although this value depends on the nature of the fibers used.

When the woven reinforcement (5) is made from fiberglass, it has a warp count ranging from 17 to 18 ends per cm and a weft count ranging from 13.5 to 14 picks per cm.

Below 17 ends per cm or 13.5 picks per cm, the woven reinforcement (5) becomes porous, especially with a denier ranging from 22 to 68 Tex.

Preferably, the woven reinforcement (5) is impregnated with a thermoplastic or thermosetting polymer in an amount ranging from 1% to 10% by weight of the impregnated woven reinforcement to avoid compromising recyclability, achieve greater rigidity, and limit or eliminate adhesive bleed-through that could clog the lamination line during the layer assembly process.

The woven reinforcement (5) may include aramid threads to provide fire-resistant properties.

The thermosetting or thermoplastic polymer can be selected from the group consisting of polyurethane resin, polyester resin, phenolic resin, epoxy resin, polysulfone, vinyl ester resin, epoxy-acrylic resin, and their mixtures.

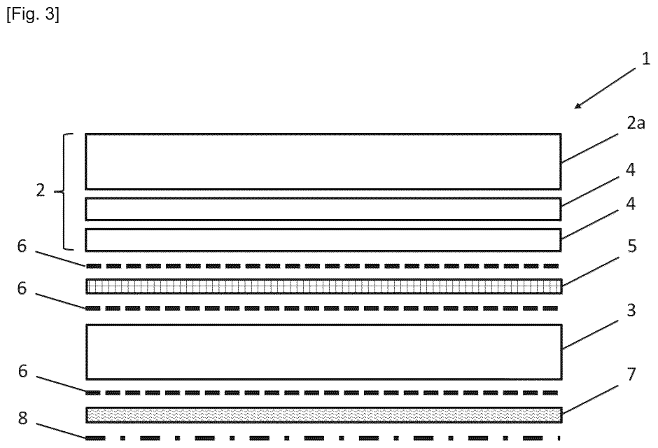

Preferably, as shown in FIG. 3 and to improve resistance against phenomena known in the art as “telegraphing”, “buckling”, or “waving”, a non-woven textile layer (7) is bonded to a lower face of the backing layer (3) through a bonding layer (6) in the form of a “hotmelt” adhesive, for example, polyurethane (PUR) or copolyester (CoPES).

The non-woven textile layer (7) preferably has a surface mass ranging from 100 g/m² to 350 g/m², preferably between 150 g/m² and 250 g/m², or even between 100 g/m² and 150 g/m². A surface mass of at least 100 g/m² improves resistance against “telegraphing,” “buckling,” or “waving.”

A surface mass greater than 350 g/m² can degrade the punching resistance of the multilayer structure (1) and increase its weight excessively. A surface mass below 100 g/m², on the other hand, may improve punching resistance but compromise resistance against “telegraphing.” Consequently, a surface mass ranging from 100 g/m² to 150 g/m² achieves a good compromise between resistance against “telegraphing” and punching resistance.

The thickness of the non-woven textile layer (7) is generally between 1.2 mm and 2.8 mm.

The non-woven textile layer (7) may include self-extinguishing fibers to

improve the fire resistance of the multilayer structure (1) while enhancing resistance against “telegraphing” of the flooring. Self-extinguishing fibers typically have an oxygen limit index (OLI) greater than 0.21 according to standard NF EN ISO 4589-2/A1. In order to achieve an OLI greater than 0.21, the non-woven textile layer (7) may include fibers selected from the group consisting of polyetherimide fibers, polyester fibers, polyacrylate fibers, aramid fibers, para-aramid fibers, oxidized polyacrylonitrile fibers, aromatic polyamide fibers, and their mixtures. The quantity of each type of fiber can easily be adjusted by a person skilled in the art to achieve an OLI value greater than 0.21, based on the OLI values of each type of fiber used in producing the non-woven textile layer (7).

Advantageously, the non-woven textile layer (7) has an OLI greater than 0.28 according to standard NF EN ISO 4589-2/A1. It has been observed that better fire resistance results for the multilayer structure (1) are obtained with a non-woven textile layer (7) having an OLI greater than 0.28 according to standard NF EN ISO 4589-2/A1. This OLI value allows the flooring according to the invention to meet the FAR 25.853 standard for fire resistance without significantly increasing the manufacturing cost of the flooring.

Advantageously, the non-woven textile layer (7) has an OLI greater than 0.32 according to standard NF EN ISO 4589-2/A1. This OLI value allows the flooring to meet the FAR 25.853 standard for fire resistance.

Advantageously, the non-woven textile layer (7) has an OLI less than 0.42, preferably less than 0.40 according to standard NF EN ISO 4589-2/A1. While OLI values greater than 0.40 are possible, the materials required to achieve them typically result in a higher cost for the flooring. Preferably, the non-woven textile layer (7) has an OLI ranging from 0.28 to 0.42 and more preferably from 0.32 to 0.40, to achieve a good compromise between manufacturing cost and fire behavior of the flooring.

Preferably, the non-woven textile layer (7) includes fibers selected from the group consisting of polyetherimide fibers, polyester fibers, polyacrylate fibers, aramid fibers, para-aramid fibers, oxidized polyacrylonitrile fibers, aromatic polyamide fibers, and their mixtures.

To improve resistance against “telegraphing” of the flooring while maintaining good fire resistance properties and limiting manufacturing costs, the non-woven textile layer (7) can be made from a mixture of polyester fibers and polyetherimide fibers, a mixture of polyester fibers and aramid fibers, a mixture of polyacrylate fibers and aramid fibers, a mixture of polyester fibers and aramid fibers, or a mixture of oxidized polyacrylonitrile fibers and para-aramid fibers.

Preferably, as shown in FIGS. 1 to 3, the multilayer structure (1) includes a repositionable double-sided adhesive (8) on a lower face intended to come into contact with the floor, such as directly on the lower face of the backing layer (3) or the lower face of the non-woven textile layer, which adheres more to the multilayer structure (1) than to the floor it is placed on, thereby facilitating installation.

The Applicant conducted tests on:
a reference product, compliant with the prior art, with a laminated backing layer;
a product A according to the invention;
a product A′ according to the invention;
a product B, not in accordance with the invention.

Products A, A′, and B have the same structure, except for the backing layer (3), which differs, and whose characteristics are detailed in the table below.

Products A, A′, and B all have:
an upper layer (2a) made of 0.50 mm thick PVC, weighing 640 g/m²;
an intermediate layer (4) made of 0.50 mm thick PVC, weighing 640 g/m²;
a bonding layer (6) in the form of a thermofusible film with a thickness of 0.045 mm, weighing 50 g/m²;
an impregnated woven reinforcement (5) with a thickness of 0.15 mm and weighing 223 g/m²;
a bonding layer (6) in the form of a thermofusible film with a thickness of 0.045 mm, weighing 50 g/m²;
a backing layer (3).

TABLE 1

| | | | Reference: Prior | | | | | | | |
|---|---|---|---|---|---|---|---|---|---|---|
| | | | art - laminated | | Backing layer | | Backing layer | | Backing layer | |
| | Standards | Requirements | reverse side | | Product A | | Product A′ | | Product B | |
| Antimony oxide | — | — | 0 | | 0% | | 0% | | 2% | |
| Type of plasticizer | — | — | 0 | | — | | DIDP- | | DIDP/DPO | |
| Plasticizer rate | — | — | — | | 0 | PCR | 21 | PCR | 37 | PCR |
| | | | | | | | | | (DIDP: 21/DPO: 16) | |
| PVC backing thickness | — | — | — | | 220 | μm | 200 | μm | 240 | μm |
| (μm) | | | | | | | | | | |
| PF weight (theoretical) | — | 1720-1750 | 1720 | g/m² | 1720 | g/m² | 1720 | g/m² | 1720 | g/m² |
| FAR 25.853 (test with | AITM 2.0002B | <15 s | OK | | 1 | s | 1 | s | 1 | s |
| adhesive, without liner) | à 12 sec | | | | | | | | | |
| Fabric - PVC | 180° peeling | >13 | OK | | 38N/25 | mm | 19N/25 | mm | 26N/25 | mm |
| adhesion - 3 J@23° C. | at 50 mm/min | | | | | | | | | |
| Fabric - PVC | 180° peeling | >13 | OK | | 33N/25 | mm | Non-testé | | 21N/25 | mm |
| adhesion - 7 J@70° C. | at 50 mm/min | | | | | | | | | |
| Backing/adh. 3M950 | ISO 4578 | ≥REF | 15N/25 | mm | 19N/25 | mm | 19N/25 | mm | 47N/25 | mm |
| adhesion - 3 J@23° C. | | | | | | | | | | |
| Backing/adh. 3M950 | ISO 4578 | >20 | 37N/25 | mm | 30N/25 | mm | 31N/25 | mm | 14N/25 | mm |

| adhesion - 7 J@70° C. | | | | | | | | | |
|---|---|---|---|---|---|---|---|---|---|
| Bending strength | ISO-2493-2 | | — | 1.4 | mN · m | 0.3 | mN · m | 0.1 | mN · m |
| (bending moment) of | | | | | | | | | |
| PVC backing layer (3) | | | | | | | | | |
| Backing heat-sealing | — | Compliant | Compliant | Non-Compliant | | Compliant | | Not tested | |
| process compatibility | | appearance | | | | | | | |

In this table, we observe that the tested product B, not covered by the invention, which has a PVC backing layer plasticized and made fire-resistant, including 37 PCR of plasticizers, is not suitable as it fails to meet the adhesion test according to ISO 4578 standard.

Specifically, the backing layer bonded to a substrate using an acrylic adhesive available on the market sold by 3M under the registered trademark 3M® reference 950, does not pass the adhesion test as per ISO 4578, which specifies that the layer should not separate with a force greater than 20 N/25 mm, whereas Product B separates with a force of 14 N/25 mm.

The reference product, i.e., the product with a laminated backing layer, product A according to the invention with a rigid PVC backing layer devoid of plasticizers, as well as product A′ according to the invention with a minimally plasticized PVC backing layer, all pass the adhesion tests to the substrate conducted according to ISO 4578 standard, using the same adhesive (3M950).

Products A and A′ also pass the adhesion tests between the PVC backing layer (3) and the woven reinforcement (5), as well as the fire tests according to FAR 25.853 standard.

Product A, which passes all the tests (mechanical, fire, etc.), is, however, not compatible with the hot thermowelding process as it deforms under the influence of heat due to the thermal sensitivity of the depolymerized backing layer (3) (0 PCR of plasticizer).

From the above, it is evident that the multilayer structure according to the invention features a low-cost backing layer compared to laminated layers. This multilayer structure satisfactorily meets the requirements in terms of the adherence of the coating to its substrate, dimensional stability, impact resistance of the floor covering, while also presenting improved recyclability.

1. Multilayer structure for the production of a floor covering, comprising at least one surface layer bonded to a backing layer, wherein the surface layer and the backing layer are made of PVC; wherein the multilayer structure has a basis weight ranging from 1500 to 2500 g/m², preferably between 1600 and 1900 g/m², and a woven reinforcement bonded to the surface layer and the backing layer through adhesive layers in the form of thermofusible films or copolyester, or cross-linked polyurethane adhesive layers; and wherein the backing layer made of PVC comprises:
a thickness ranging from 150 μm to 600 μm, preferably between 150 μm and 300 μm;
less than 25 PCR of plasticizer, preferably less than 15 PCR.

2. Multilayer structure according to claim 1, wherein the backing layer made of PVC has a bending strength measured according to ISO 2493-2 ranging from 0.1 mN·m to 30 mN·m, preferably between 0.1 and 2 mN·m, more preferably between 0.1 and 1 mN·m.

3. Multilayer structure according to claim 1, wherein the backing layer has a thickness ranging from 150 μm to 300 μm, preferably between 170 μm and 250 μm.

4. Multilayer structure according to claim 1, wherein the backing layer comprises 2% or less of flame retardants.

5. Multilayer structure according to claim 1, wherein the surface layer comprises an upper layer and one or more intermediate layers of plasticized PVC.

6. Multilayer structure according to claim 4, wherein the upper layer is transparent, and the intermediate layer directly positioned beneath the upper layer is a printed decorative film.

7. Multilayer structure according to claim 1, wherein the woven reinforcement is impregnated with a thermoplastic or thermosetting polymer in an amount ranging from 1% to 10% by weight of the impregnated woven reinforcement.

8. Multilayer structure according to claim 1, wherein a non-woven textile layer is bonded to a lower surface of the backing layer through a bonding layer in the form of cross-linked polyurethane or a thermoplastic copolyester layer.

9. Multilayer structure according to claim 7, wherein the non-woven textile layer comprises aramid fibers.

10. Multilayer structure according to claim 1, wherein the multilayer structure further comprises a repositionable double-sided adhesive layer on a lower surface intended to be facing the floor.
